(19) United States
(12) Patent Application Publication
(10) Pub. No.: US 2022/0282921 A1
(43) Pub. Date: Sep. 8, 2022

(54) DOMES AND ARCHES

(71) Applicant: DINGLEY DELL ENTERPRISES LIMITED, Worcestershire (GB)

(72) Inventor: Jolyon Eric Emery, Kidderminster Worcestershire (GB)

(21) Appl. No.: 17/626,462

(22) PCT Filed: Jul. 2, 2020
(86) PCT No.: PCT/GB2020/051586

§ 371 Date: Jan. 11, 2022

(30) Foreign Application Priority Data
Jul. 23, 2019 (GB) 1910537.8
Jul. 23, 2019 (GB) 1910539.4
Jul. 23, 2019 (GB) 1910541.0

(51) Int. Cl. F27D 1/14; A21B 1/33; F27D 1/00

(52) U.S. Cl. CPC F27D 1/147; A21B 1/33; F27D 1/0006; F27D 1/004; F27D 1/0043; F27B 3/205

(57) ABSTRACT

A modular dome structure (5) for a masonry oven, which includes a plurality of interlocking wall modules (60) abutting one another to form a wall of the dome and a base (7) upon which the wall modules are mounted. Each wall module (60) is formed of a plurality of blocks (63) hingedly interconnected together and shaped so as to form an arch segment of the dome wall when facing surfaces of adjacent blocks (63) of the wall module (60) abut and interlock with one another.

This invention relates generally to domes and arches, kits for assembly into such domes and arches, modules for such kits and methods of assembly and manufacture of such domes and arches, kits and modules. More specifically, although not exclusively, this invention relates to modular dome structures for ovens, particularly masonry ovens having a wall formed of a refractory material, or other structural domes and arches.

Masonry ovens, also known as a brick, stone, Roman, black and/or pizza ovens, include a baking chamber made of fireproof brick, concrete, stone, clay, or cob. Traditional wood- or coal-fired ovens are becoming increasingly popular both in restaurants and in the home, although modern masonry ovens are sometimes fired with natural gas or bottled propane or butane. Modern masonry ovens are often associated with artisanal bread and pizza, but they can be used to prepare baked dishes or any food dishes that require high searing grilling baking brazing smoking slow cooking frying.

Typically, the construction of modern masonry ovens is similar to traditional construction practices. Such construction may involve the use of mud, brick, or modern refractory materials, but any such oven is essentially a masonry shell. Early ovens were formed of clay soil, usually tempered with sand to reduce cracking, built up over a form of sticks or sand. When the clay was sufficiently stiff, a doorway would be cut into the structure and the sand would be removed or the wood was burned out.

Brick ovens were laid up either over a frame or free-form. In the free-form technique, the first course is a circle of bricks, the next course is laid on a wedge-shaped mortar bed and each succeeding circle of brick sits at a steeper pitch and draws the dome closer to the centre. Suction between dry bricks and wet mortar holds bricks in place until the courses approach vertical and the top of the dome is closed with the central keystone. Some modern square or polygonal ovens can be built with tapered arch bricks, but often require buttressing.

All of the aforementioned construction techniques require substantial time and skill. As such, masonry ovens tend to be expensive and usually must be built in-situ. Indeed, pre-cast ovens tend to have heavy and unwieldy sections, which require specialist equipment for installation.

It would be desirable to provide a dome or arch structure, and associated method of construction, which is simpler, easier and/or more cost effective to erect. Such structures and methods are particularly useful in masonry ovens, but can also be used in other dome and arch structures.

Accordingly, a first aspect of the invention provides an arch or arch segment comprising a plurality of blocks hingedly interconnected together and shaped so as to form an arch when facing surfaces of adjacent blocks of the wall module abut one another.

The provision of a plurality of hinged blocks shaped to form an arch enables dome and arch structures to be stored, transported and erected quickly and simply.

The arch segment may be movable from a first, e.g. substantially flat, configuration to a second, e.g. arched, configuration. The arch segment may be in the second configuration when facing surfaces of adjacent blocks abut one another.

Another aspect of the invention provides a dome or dome structure, e.g. a modular dome structure, comprising a plurality of wall modules forming a wall of the dome and a base upon which the wall modules are mounted, wherein each wall module comprises a plurality of blocks hingedly interconnected together and shaped so as to form an arch segment of the dome wall when facing surfaces of adjacent blocks of the wall module abut one another.

At least one of the blocks may be angled or tapered or comprise an angled or tapered surface, for example to form the arch segment. At least one of the blocks may be angled, or may taper. The angle or taper may be toward the inside or internal side of the dome or dome structure. The angle or taper may be toward an intended inside or internal side of a dome or dome structure within which the arch or arch segment may be comprised or incorporated, in use. The taper or angle may be along or across the depth of the block. The taper or angle may be along one or more sides of the block.

In some examples the taper or angle is along four sides of the block. The taper or angle may be along or across opposed portions of the blocks in the or each arch segment or wall module, e.g. to form the arch segment. The taper or angle may be along or across portions of one or more blocks in one arch segment or wall module which face or opposed one or more adjacent blocks in another arch segment or wall module, for example to enable the wall modules or arch segments to form a substantially hemispherical or polygonal dome.

At least one of the blocks may comprise a first thickness and a second thickness. The second thickness may be less than the first thickness, e.g. such that the block tapers. The first thickness may be at or adjacent a first side of the block. The first thickness may be at or adjacent the hinged connection. The second thickness may be at or adjacent a second side of the block, e.g. opposite the first side. The second thickness may be at or adjacent the inside or internal side of the dome or dome structure. The second thickness may be at or adjacent an intended inside or internal side of a dome or dome structure within which the arch or arch segment may be comprised or incorporated, in use.

At least one block may be offset relative to at least one adjacent block, for example such that the arch segment interlocks, in use, with another arch segment, e.g. to provide an interlocking structure. The wall modules may abut one another and/or interlock with one another, e.g. to form the wall of the dome. The blocks of adjacent wall modules may describe an interlocking pattern.

The arch segment or each wall module may comprise first and second ends. The first end may comprise a mounting end. The first end may be mounted or secured to the base. The second end, which may be opposite the first end, may comprise a free end.

At least one or each block may comprise a flexible member or spine, which may be moulded, and/or at least partially embedded, therein, e.g. to provide the hinged interconnection. The flexible member or spine may comprise one or more wires, e.g. one or more twisted multifilament wires. The flexible member or spine may extend from the first end of the wall module to its second end. The arch segment or at least one or each wall module may comprise a pair of flexible members or spines or wires, which may extend from its first end to its second end. The arch segment or at least one or each wall module may comprise two or more, e.g. a plurality of, flexible members or spines or wires, which may extend from its first end to its second end.

The arch segment or at least one or each wall module may comprise a registration feature or connector, e.g. at its first end. The or each registration feature or connector may, but need not, be secured to the or a respective one of the flexible members or spines. The arch segment or at least one or each wall module may comprise a pair of registration features or connectors, e.g. at its first end. When the arch segment or wall module comprises a pair of flexible members or spines, each flexible member or spine may, but need not, have a registration feature or connector secured thereto, e.g. at the first end. The or each registration feature or connector may be registered or registrable in and/or connected or connectable to a respective registration feature or connector of the base, e.g. to mount, retain and/or secure the wall module to the base.

The arch segment or at least one of the wall modules may comprise at least one registration feature, e.g. one or more first registration feature(s). The base may comprise one or more, e.g. a plurality of, registration features, for example one or more second registration feature(s). The registration feature(s) of the base may cooperate with corresponding registration feature(s) of at least one of the wall modules, for example to locate the wall modules relative to the base. The first registration feature at the first end of the arch segment or at least one of the wall modules may be in registration with the second registration feature of the base, e.g. to locate the wall module on the base.

Another aspect of the invention provides a dome or dome structure, e.g. a modular dome structure, comprising a plurality of wall modules forming a wall of the dome and a base upon which the wall modules are mounted, wherein the base comprises one or more, e.g. a plurality of, registration features which cooperate with corresponding registration feature(s) of at least one of the wall modules to locate the wall modules relative to the base.

Another aspect of the invention provides a base for a dome or dome structure, e.g. a modular dome structure, the base comprising a plurality of registration features configured to cooperate with corresponding registration features of each of a plurality of wall modules to locate the wall modules relative to the base such that the wall modules form a wall of a dome.

The registration feature(s) of the base may comprise a projection, ridge or key and/or the registration feature(s) of the arch segment or wall module(s) may comprise a recess, notch or keyway. Alternatively, the registration feature(s) of the arch segment or wall module(s) may comprise a projection, ridge or key and/or the registration feature(s) of the base may comprise a recess, notch or keyway. The arch segment or wall module(s) may rest on the base. Additionally or alternatively, the dome or dome structure may comprise a strap, which may be secured to and/or wrapped around at least some or all of the wall modules and/or the base.

At least one or each module may comprise a first position and/or a second position. The first position may comprise a locked position, e.g. in which the wall module is mounted or secured to, or held or retained by, the base. The second position may comprise an unlocked position, e.g. in which the wall module is removable from the base. The registration features may be configured to enable at least one or each wall module to be movable, e.g. between the first and second positions.

The base may comprise or be a registration plate, which may comprise the registration feature(s) of the base. The base may comprise one or more slabs, which may be received on the registration plate, e.g. to describe a floor. The or each registration feature may comprise a connector. The or each registration feature or connector of the base or registration plate may comprise a keyway or key. The or each registration feature or connector of the arch segment or the or each wall module may comprise a key or keyway.

The or each key may be received and/or retained within one of the keyways, e.g. a respective keyway. The or each key may be retained within the keyway in the first position. The or each key may be removable from the keyway in the second position. The or each keyway may comprise a slot. The slot may comprise an enlarged portion and/or a necked portion. The or each key may comprise a projection. The or each key or projection may comprise a head and/or a neck. The neck of the key or projection may be received within the necked portion of the keyway, for example in the first position. The neck of the key or projection may be received within the enlarged portion and/or the head of the key or projection may be aligned with the enlarged portion, for example in the second position.

When the arch segment or wall module comprise a pair of keys, both connectors thereof may be received and/or retained within the same keyway. The or each keyway may comprise a slot with two enlarged portions. A first of the enlarged portion may be at an end of the slot and/or a second of the enlarged portions may be at or in an intermediate part of the slot. The enlarged portions may be joined by a first necked portion. The slot may comprise a second necked portion, which may extend from one of the enlarged portions, e.g. the second enlarged portion. The neck of each of the pair of keys may be received within the second necked portion in the first position. The neck of each of the pair of keys may be received within a respective one of the enlarged portions in the second position.

The registration features may comprise an initiating registration feature. The initiating registration feature may be configured to register a first of the wall modules, e.g. prior to the registration of the other wall modules. The initiating registration feature may comprise a keyway or slot, e.g. as described above. The initiating keyway or slot may comprise an enlarged portion and/or a necked portion. The necked portion of the initiating keyway or slot may extend from the enlarged portion toward a periphery of the base or registration plate and/or away from a centre of the base or registration plate. The first wall module may comprise a registration feature, which may comprise a key, e.g. having a head and neck as described above. The registration feature of the first wall module may cooperate with the initiating registration feature.

The registration features may comprise a second registration feature, which may be on a first side of the initiating registration feature. The second registration feature may be configured to register a second of the wall modules, e.g. after the first wall module is registered in the initiating registration feature. The second registration feature may comprise a keyway or slot, e.g. as described above. The second keyway or slot may comprise an enlarged portion and/or a necked portion. The necked portion of the second keyway or slot may extend from the enlarged portion toward the initiating registration feature. The second registration feature, keyway or slot may be perpendicular or orthogonal to the initiating registration feature or keyway or slot. The second wall module may comprise a registration feature, which may comprise a key, e.g. having a head and neck as described above. The registration feature of the second wall module may cooperate with the second registration feature.

An adjacent pair of wall modules may be interlocked with one another, for example when both wall modules are in their first position. The or an adjacent pair of wall modules may be disengaged from one another, for example when one of the modules is moved to its second position. The adjacent pair of wall modules may comprise the first and second wall modules. The second module may be disengaged from the first module, for example when it is moved to its second position.

The registration features may comprise a third registration feature, which may be on a second side of the initiating registration feature, e.g. opposite the first side. The third registration feature may be configured to register a third of the wall modules, e.g. after the first wall module is registered in the initiating registration feature. The third registration feature may comprise a keyway or slot, e.g. as described above. The third keyway or slot may comprise an enlarged portion and/or a necked portion. The necked portion of the third keyway or slot may extend from the enlarged portion toward the initiating registration feature. The third registration feature, keyway or slot may be perpendicular or orthogonal to the initiating registration feature or keyway or slot. The third wall module may comprise a registration feature, which may comprise a key, e.g. having a head and neck as described above. The registration feature of the third wall module may cooperate with the second registration feature.

The first and third wall modules may be interlocked with one another, for example when both wall modules are in their first position. The or an adjacent pair of wall modules may be disengaged from one another, for example when one of the modules is moved to its second position. The third module may be disengaged from the first module, for example when it is moved to its second position.

The first wall module may be captivated between and/or interlocked with the second and third wall modules, e.g. when each is in its first position. The second wall module may be movable in a first direction from its first position to its second position. The third wall module may be movable in a second direction from its first position to its second position. The second direction may be opposite the first direction. The initiating registration feature may be configured such that the first wall module is movable between the first and second positions in a direction substantially perpendicular to the first and second directions. The first and second directions may extend away from the initiating registration feature.

Another aspect of the invention provides a dome or dome structure, e.g. a modular dome structure, comprising an inner dome wall, a base upon which the inner dome wall is mounted and a hood, wherein the hood is removably mounted to the base over the inner dome wall.

The dome or dome structure may comprise a plurality of wall modules, which may abut one another to form the inner dome wall.

Another aspect of the invention provides a hood for a modular dome structure.

The registration features of the base or registration plate may be inboard of its periphery, e.g. to provide a peripheral ledge about the modular dome structure. The dome or dome structure may comprise a hood, which may be removable. The hood may be received over the wall modules and/or be supported at least in part by the base, e.g. the peripheral ledge thereof. The wall of the dome may comprise an inner wall.

The hood may comprise one or more registration features, e.g. connectors or tabs. The base or registration plate may comprise one or more hood registration features, e.g. connectors or slots. The hood registration feature(s) of the base or registration plate may receive or be configured to receive the registration feature(s) of the hood, e.g. for registering, locating and/or securing the hood on or to the base or registration plate.

The dome or dome structure may comprise one or more doorframe modules. The doorframe module(s) may be between or located between a pair of the wall modules. The doorframe module(s) may describe an opening or door opening of the dome or dome structure. The hood, dome or dome structure may comprise an opening and/or a door or door panel, e.g. for covering or selectively covering the opening. The door or door panel, hereinafter door, may be movable or removable and/or may comprise a handle. The door may comprise one or more registration features, connectors or tabs. The base or registration plate may comprise one or more door registration features, connectors or slots. The door registration feature(s) of the base or registration plate may receive or be configured to receive the registration feature(s) of the door.

For the avoidance of doubt, the registration, connection, securement, holding or retention of any of the registration features, connectors, tabs and slots may be removable and/or releasable.

The dome or dome structure may comprise a lid or cap. The lid or cap may be mounted on the free end of each wall module. The lid or cap may be secured to each wall module by a locking band or plate, e.g. a common locking band or plate or a plurality of respective locking bands or plates. The lid or cap may comprise a crown and/or may describe an aperture. The hood, dome or dome structure may comprise a chimney or flue, which may be in fluid communication, in use, with the aperture of the lid or cap, e.g. for evacuating combustion gases. Alternatively, the lid or cap may be closed and the hood, dome or dome structure, or the chimney or flue thereof, may comprise ducting for directing combustion gases exiting the door opening up through the chimney or flue.

The base or registration plate or at least one of the slabs of the base may comprise an aperture, e.g. for receiving or communicating with a gas burner.

At least one or each block of at least one or each wall module may comprise a brick. The inner wall or the or each wall module, block or brick may be formed at least in part of a refractory material, which may be moulded. The inner wall or the or each wall module, block or brick may have a refractory material on an inner facing side or surface thereof. The dome or dome structure may comprise a fire resistant filler or mortar, which may be between the blocks or in one or more spaces described between adjacent blocks.

The hood, dome or dome structure may comprise a fire-retardant and/or insulating material, e.g. a thermally insulating material. The fire-retardant and/or insulating material may be in, below or on the base or registration plate. The registration plate may comprise a peripheral lip, e.g. a depending peripheral lip. The fire-retardant and/or insulating material may be received within the peripheral lip, below or beneath the registration plate. The fire-retardant and/or insulating material may be on an inner side of the hood. The fire-retardant and/or insulating material may surround or be on an outer side of the dome wall or wall modules. The fire-retardant and/or insulating material may be between the hood and the dome wall or wall modules.

The dome or dome structure may comprise an oven, e.g. a masonry oven. Alternatively, the dome or dome structure may comprise a shelter or house. The arch segment may comprise an arch or part of an arch, e.g. for supporting soil, earth or an aggregate material.

The hood may comprise a stainless steel material. The hood may be formed of a plurality of panels, which may be secured, e.g. welded or riveted, to one another. The hood may comprise a natural or synthetic material. The hood may comprise a clay material. The hood may comprise a composite material. The hood may comprise a decorative pattern. The hood may be painted. The hood may be omitted, for example to enable a user to build a bespoke cover over the dome or dome structure.

Another aspect of the invention provides a method of assembling a dome or dome structure, e.g. a modular dome structure, the method comprising forming each of a plurality of wall modules into an arch segment by pivoting each of a plurality of hingedly interconnected blocks thereof about their hinged connection until facing surfaces of adjacent blocks of the wall module abut one another and mounting the wall modules to a base such that the arch segments abut one another to form a wall of the dome.

Mounting the wall modules to the base may comprise mounting or securing a first, mounting end of each wall module to the base, for example to cantilever the arch segment. Mounting the wall modules to the base may comprise registering a registration feature of each wall module with a corresponding registration feature of the base. Mounting the wall modules to the base may comprise moving each wall module, e.g. relative to the base. Each wall module may be moved from a first and/or unlocked position to a second and/or locked position. Adjacent wall modules may abut one another to form a wall of the dome in the locked position.

Another aspect of the invention provides a method of assembling a dome or dome structure, e.g. a modular dome structure, the method comprising mounting each of a plurality of wall modules to a base by registering a registration feature of the wall module with a corresponding registration feature of the base and moving the wall module relative to the base from an unlocked position to a locked position in which adjacent wall modules abut one another to form a wall of the dome.

The method may comprise mounting a first wall module to the base, for example by registering a registration feature of the first wall module with a registration feature, e.g. an initiating registration feature, of the base. Mounting the first wall module to the base may comprise moving the first wall module, e.g. relative to the base. The first wall module may be moved from an unlocked position to a locked position.

The method may comprise mounting a second wall module to the base, for example after the first wall module. Mounting the second wall module may comprise registering a registration feature of the second wall module with a registration feature, e.g. a second registration feature, of the base. Mounting the second wall module to the base may comprise moving the second wall module, e.g. relative to the base. The second wall module may be moved toward the first wall module or arch segment. The second wall module may be moved from an unlocked position to a locked position. The first and second arch segments may be interlocked with one another in the locked position. The second arch segment may be mounted to the base on a first side of the first arch segment.

The method may comprise mounting a third wall module to the base. The third wall module may be mounted on second side of the first wall module or arch segment, e.g. opposite the first side. Mounting the third wall module to the base may comprise registering a registration feature of the third wall module with a registration feature, e.g. a third registration feature, of the base. Mounting the third wall module to the base may comprise moving the third wall module, e.g. relative to the base. The third wall module may be moved toward the first wall module or arch segment from an unlocked position to a locked position, in which the first and third arch segments are interlocked with one another.

The direction in which the first wall module is moved, e.g. relative to the base and/or from the unlocked position to the locked position, may be perpendicular to the direction in which the second and/or third wall module is/are moved, e.g. relative to the base and/or from its/their unlocked position to its/their locked position.

The method may comprise mounting a lid or cap on a free end of each arch segment. The lid or cap may comprise a crown, which may describing an aperture. The method may comprise mounting a chimney or flue to the modular dome structure, for example in fluid communication with the aperture, e.g. for evacuating combustion gases. Alternatively, the lid or cap may be closed and the method may comprise mounting the chimney or flue in fluid communication with ducting configured to direct combustion gases exiting the door opening up through the chimney or flue.

Moving a wall module may, but need not, be carried out with the wall module formed as an arch segment. However, when the wall modules interlock it may be necessary for the wall module to be moved whilst formed as an arch segment.

Another aspect of the invention provides a method of manufacturing a wall module or arch segment, the method comprising introducing a pliable material into a mould describing a plurality of block or brick cavities, inserting a flexible spine into the mould, such that it is embedded within the pliable material in each brick cavity, and removing from the mould, after the pliable material has hardened or set, a moulded arch segment including a plurality of blocks or bricks within which the flexible spine is moulded such that the bricks are hingedly interconnected together.

The flexible spine may be one of a pair of flexible spines which are inserted into the mould, e.g. such that they are embedded within the pliable material in each brick cavity.

The method may comprise inserting or securing, either before, during or after the hardening or setting of the pliable material, a registration feature or key to or in the wall module or arch segment.

Another aspect of the invention provides a mould for manufacturing a wall module or arch segment. The mould may describe a plurality of block or brick cavities. The mould may be for carrying out the aforementioned method.

Another aspect of the invention provides a method of retrofitting a dome or dome structure, e.g. a modular dome structure, the method comprising removing, from the dome or dome structure, a hood mounted to a base and surrounding an inner dome wall of the dome or dome structure and replacing the hood with a further hood by mounting it to the base over the inner dome wall of the dome or dome structure.

The method may comprise disconnecting one or more connectors of the hood from a corresponding one or more connectors of the base, e.g. before the hood is removed. The method may comprise removing one or more tabs from a corresponding one or more slots of the base within which the tabs are received, e.g. before the hood is removed.

For the avoidance of doubt, any of the features described herein apply equally to any aspect of the invention. For example, the dome or dome structure may comprise any one or more features of the arch segment or hood relevant thereto or vice versa. Similarly, any of the aforementioned methods may comprise any one or more features or steps relevant to one or more features of the dome or dome structure, the arch segment or the hood and vice versa.

Another aspect of the invention provides a computer program element comprising and/or describing and/or defining a three-dimensional design for use with a simulation means or a three-dimensional additive or subtractive manufacturing means or device, e.g. a three-dimensional printer or CNC machine, the three-dimensional design comprising an embodiment of the dome or dome structure, wall module or arch segment described above.

A yet further aspect of the invention provides the computer program element embodied on a computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

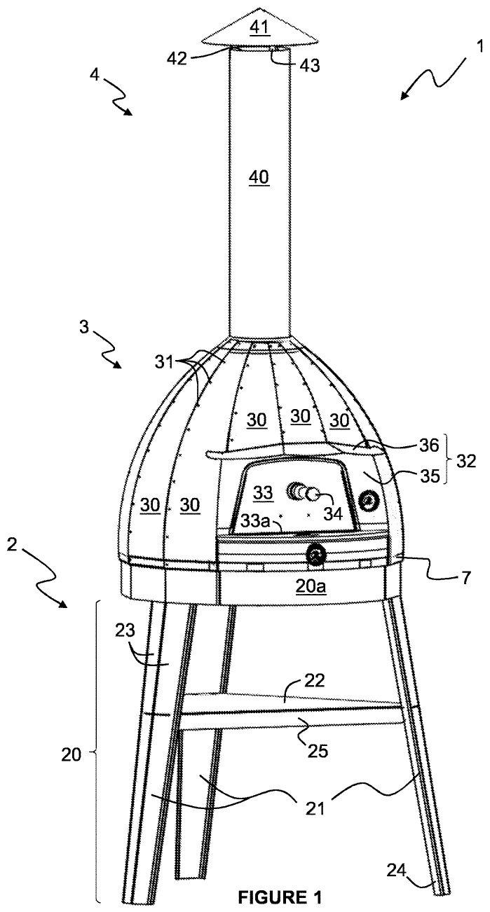

FIG. 1 is an isometric view of an oven incorporating aspects of the invention;

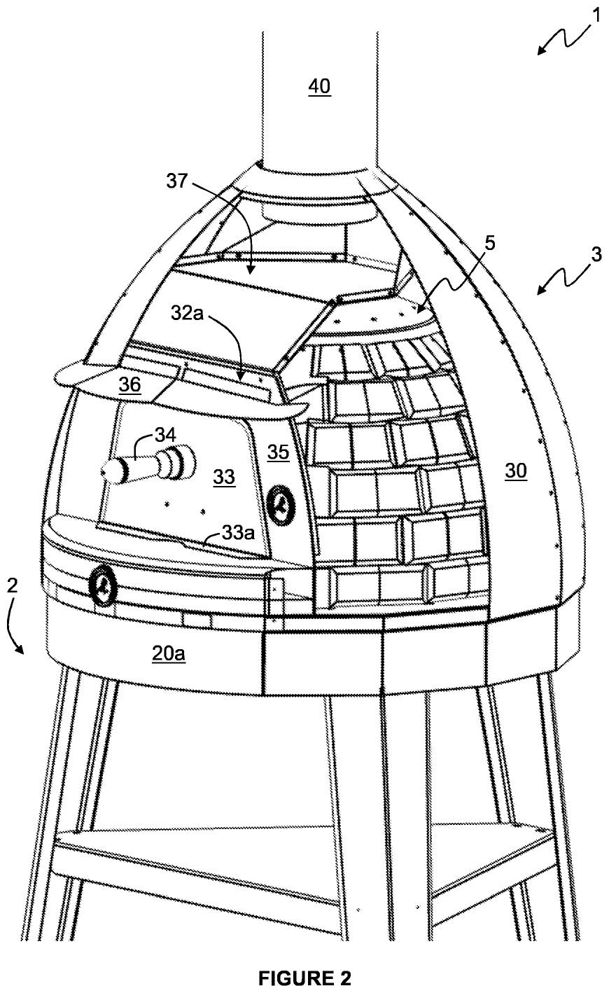

FIG. 2 is an enlarged isometric view of the oven of FIG. 1 with some of the panels omitted to illustrate the flue ducting;

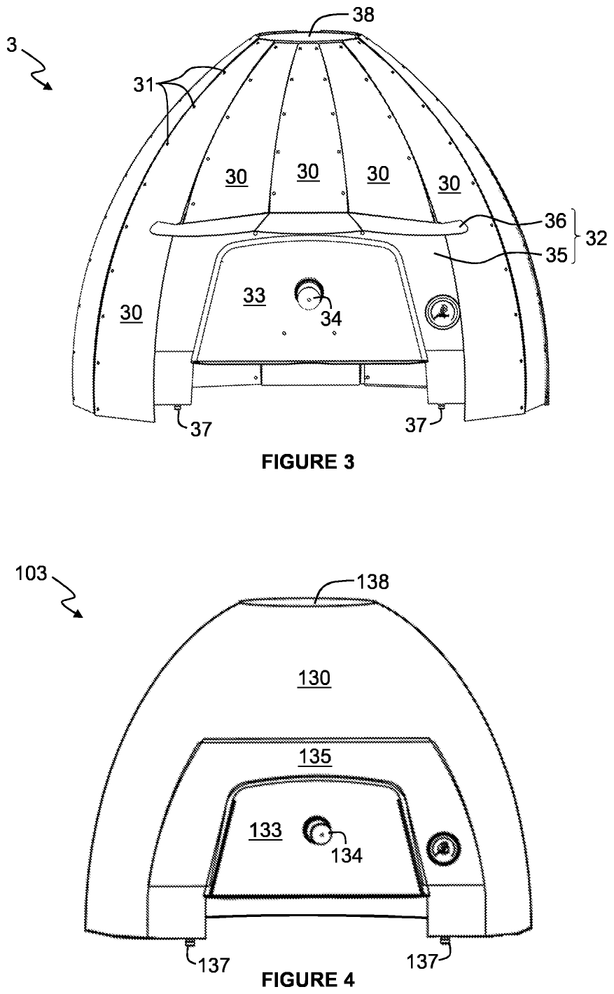

FIG. 3 is a front view of the hood of the oven of FIGS. 1 and 2 with the chimney omitted;

FIG. 4 is a front view of a hood according to another example with the chimney omitted;

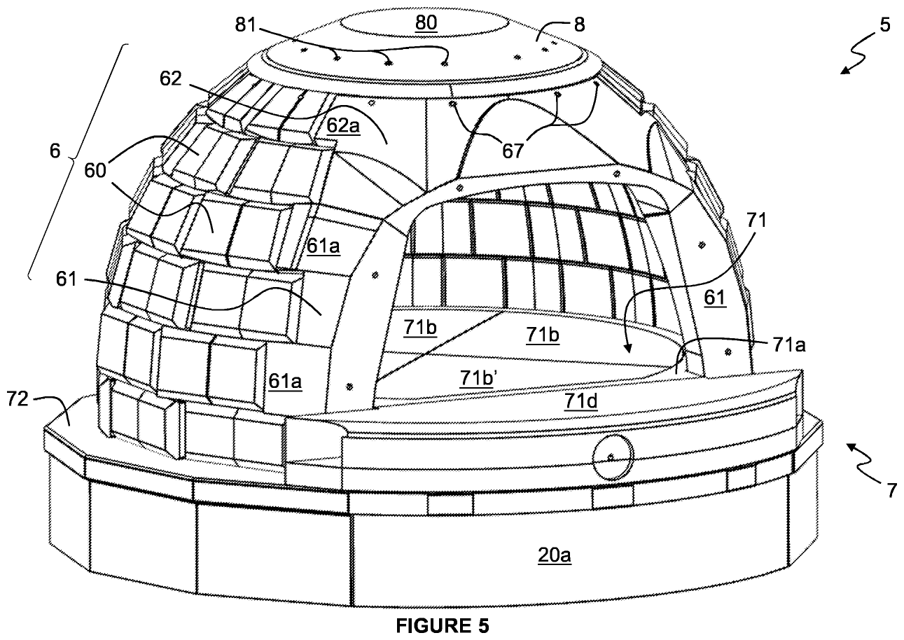

FIG. 5 is an isometric view of a modular dome structure forming the core of the oven of FIGS. 1 and 2;

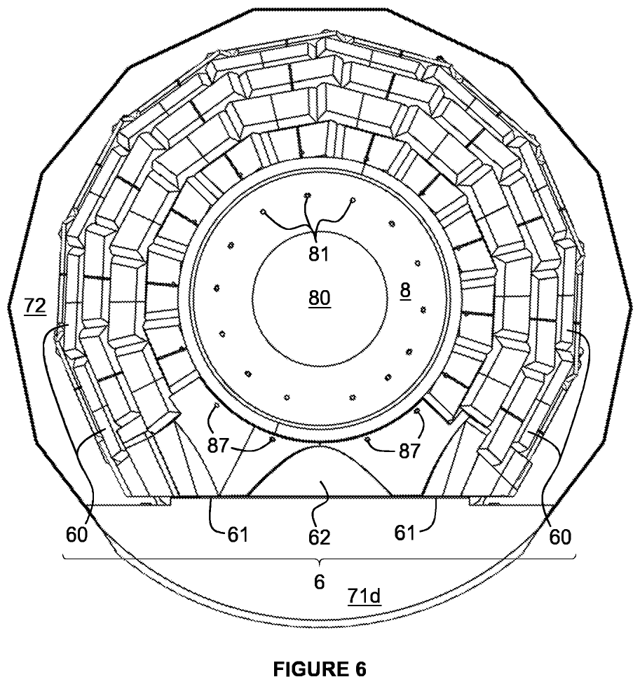

FIG. 6 is a top view of the modular dome structure of FIG. 5;

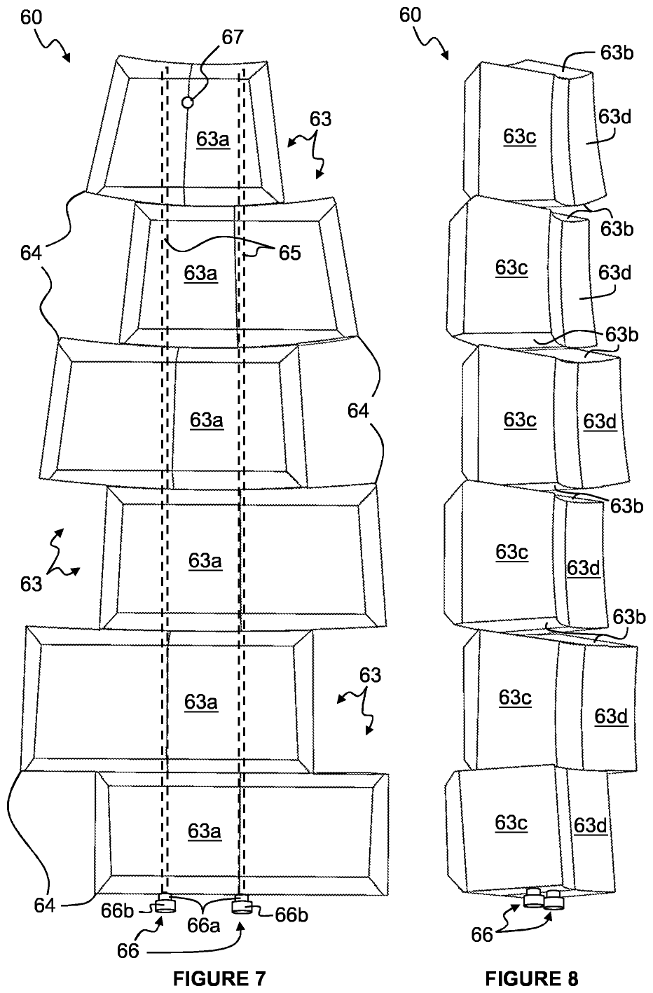

FIG. 7 is a plan view of the outer side of one of the wall modules of the modular dome structure of FIGS. 5 and 6, shown in a flat configuration;

FIG. 8 is a side view of the wall module of FIG. 7;

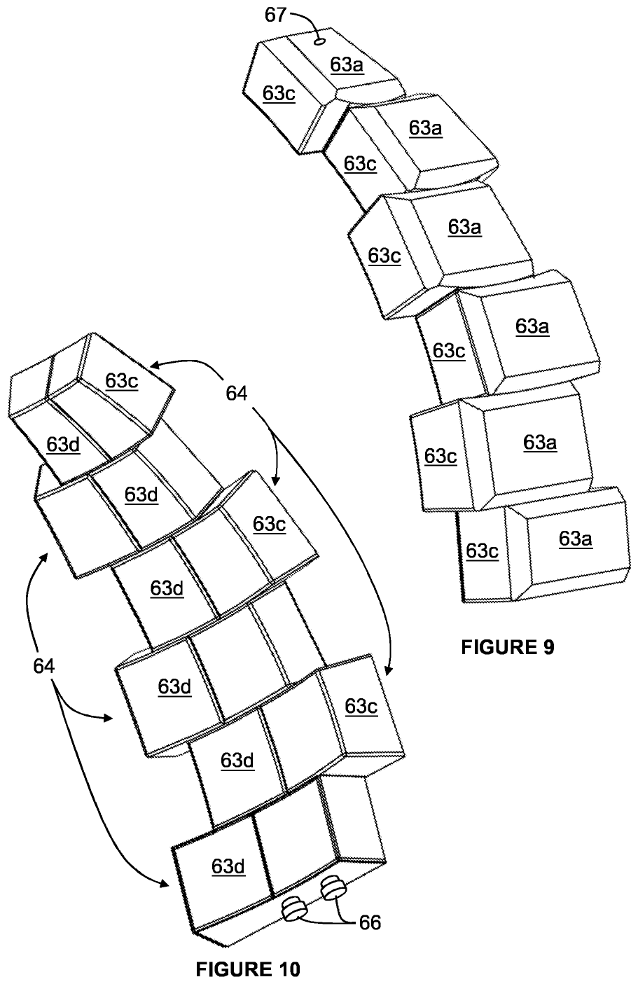

FIG. 9 is an isometric view from an outer side of the wall module of FIGS. 7 and 8, formed into an arch segment;

FIG. 10 is an isometric view of an inner side of the wall module of FIG. 9;

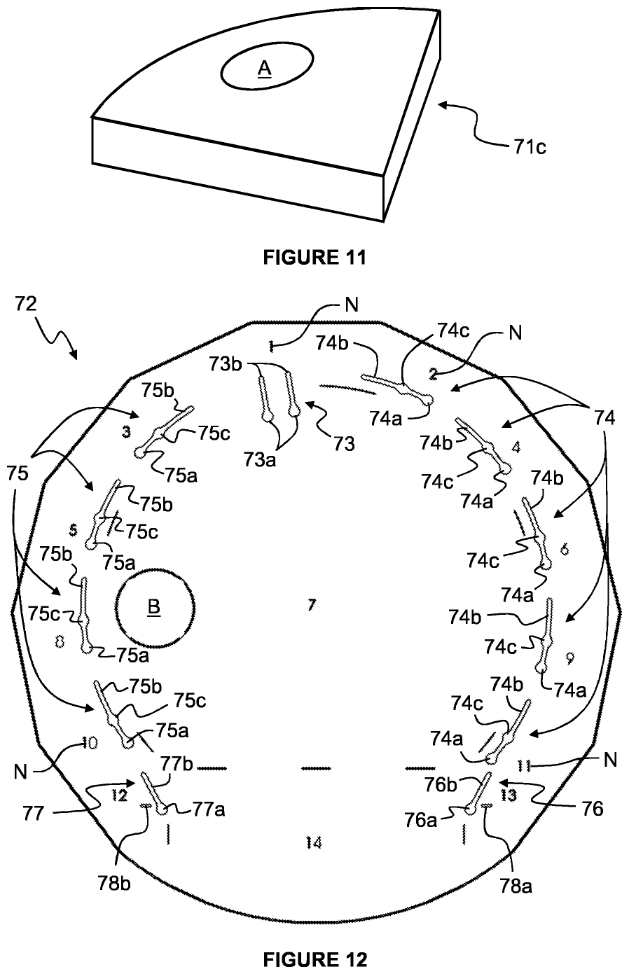

FIG. 11 is an isometric view of one of the floor slabs of the modular dome structure of FIGS. 5 and 6;

FIG. 12 is a plan view of the registration plate of the modular dome structure of FIGS. 5 and 6;

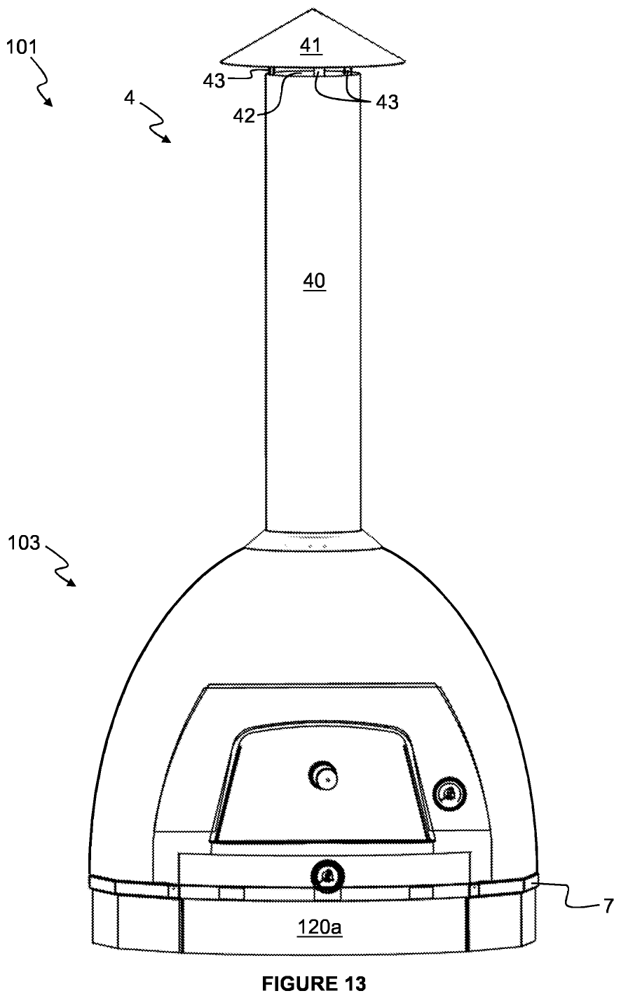

FIG. 13 is a front view of an oven including the hood of FIG. 4 over the modular dome structure of FIGS. 5 and 6, without a stand.

Referring now to FIGS. 1 to 3, there is shown an oven 1 including a stand 2, a hood 3 and a chimney 4. Beneath the hood 3, the oven 1 includes a modular dome structure 5 forming a masonry core of the oven 1. The modular dome structure 5 (shown more clearly in FIGS. 5 and 6) includes a plurality of wall modules 6 mounted to a base 7 and a lid 8 mounted on the wall modules 6.

The stand 2 includes a subframe 20 upon which the base 7 of the dome structure 5 is mounted. The subframe 20 includes a pedestal 20a, three legs 21 diverging from the pedestal 20a and an intermediate shelf 22 connected to an intermediate part of each leg 21 to provide structural stability. Each leg 21 is formed of a length of sheet metal, which is bent to form a pair of flanks 23 extending along the length of the leg 21 and flanges 24 extending from each of the outer longitudinal edges of the flanks 23 and substantially perpendicularly thereto. The shelf 22 is substantially triangular in plan, with a peripheral wall 25 to stiffen the subframe 20. It will be appreciated that this stand 2 is purely optional; it may be omitted or replaced with any suitable design.

The hood 3 is formed of a plurality of panels 30, formed of stainless steel in this example, which extend from the top of the hood 3 to the base 7. The panels 30 are secured together along their edges by a series of rivets 31. The hood 3 also includes a door surround 32 and a trapezoidal door panel 33 with a handle 34 secured to and extending from the centre of the door panel 33. The door surround 32 includes an arch-shaped panel 35 and a brim panel 36 projecting from the arch-shaped panel 35 over the door panel 33. Insulative layers (not shown) are also included on a rear side of the arch-shaped panel 35 and behind the door panel 33. The door panel 33 in this example is unattached to the door surround 32 and includes an orthogonal foot portion 33a to keep it upright when it is placed against the door surround 32 to cover the door opening.

As shown in FIG. 2, the door surround 32 is flat, while the panels 30 bow away from the door surround 32 to create a gap 32a therebetween. The hood 3 includes flue ducting 37, which extends from the door panel 33 to the panels 30, surrounding the apex of the hood 3 to create a plenum therebetween, with the gap 32a between the panels 30 and the door surround 32 providing an inlet thereto. As shown more clearly in FIG. 3, the arch-shaped panel 35 includes a pair of registration tabs 38 depending from each of its lower limbs and an aperture 39 at its apex, which provides an outlet of the plenum described by the flue ducting 37.

The chimney 4 includes a cylindrical flue 40 projecting from the top of the hood 3 and in fluid communication with the aperture 39 of the hood 3. The chimney 4 also includes a conical cowl 41 secured to the open top 42 of the flue 40. The cowl 41 is secured to the flue 40 by three connecting members 43, such that a space is created therebetween to allow for the passage of combustion gases. In use, combustion gases escaping from the door opening pass through the gap 32a between the panels 30 and the door surround 32, into the plenum described between the flue ducting 37 and panels 30, through the aperture 39 of the hood 3, up the cylindrical flue 40 and out through the space between the open top of the cylindrical flue 40 and the cowl 41.

FIG. 4 illustrates an alternative hood 103, which is similar to the hood 3 described above, wherein like features are labelled with like references with the addition of a preceding ‘1’. The hood 103 in this example differs from the hood 3 described above in that it is formed as a singled piece 130 from a composite material, instead of the use of the aforementioned panels. The internal and external shape and dimensions are similar and, as such, one aspect of the invention provides interchangeable hoods 3, 103 for use with the same core structure 5. An example of this is illustrated in FIG. 13, which illustrates an oven 101 resting atop a pedestal 120a without any legs 21 or shelf 22. It will be appreciated that, whilst the shape of the pedestal 120a matches that of the base 7, this need not be the case. The oven 101 may rest on a special purpose table (not shown), a brick support structure (not shown) or any other suitable, non-flammable substrate.

Turning now to FIGS. 4 to 9, the wall modules 6 forming the modular dome structure 5 in this example include ten arch segment wall modules 60, a pair of side doorframe modules 61 and an upper doorframe module 62. However, it will be appreciated that the number of wall modules 6 may vary, for example in the case of larger or smaller ovens (not shown). The side doorframe modules 61 include a series of castellations 61a and the upper doorframe module 62 includes a single castellation 62a. In the assembled condition, the side doorframe modules 61 support the upper doorframe module 62 to describe a door opening.

Each of the arch segment wall modules 60, shown more clearly in FIGS. 6 to 9, includes a series of blocks or bricks 63, hereinafter bricks 63, which are offset or staggered from one another to provide a series of castellations 64 along its length. The bricks 63 are hingedly interconnected by a pair of flexible spines 65, in the form of a stainless steel wire in this example, which are embedded within each brick 63 adjacent its outer side 63a. A pair of keys 66 are also secured to the lowermost, largest brick 63, at a mounting end of each arch segment wall module 60. A similar key (not shown) is also included on the base of each side doorframe module 61. Each key 66 is in the form of a projection or lug having a head 66a and a neck 66b. In this example, each key 66 is aligned with one of the spines 65 and may be secured thereto, although this is not necessary.

The use of spines 65, particularly a pair of spines 65 and the use of wire, provides advantages over conventional reinforcing techniques. More specifically, these spines 65 provide a reinforcing structure that extends along the entire wall of the dome structure 5, from the base to the top. This provides a more robust reinforcement than conventional reinforcing or filament reinforcing. Conventional oven manufacturing techniques fail to optimise the orientation of such filaments. These filaments are also susceptible to falling out of the matrix forming the wall of the oven 1, which could fall into the food being cooked with the oven 1.

In this example, the bricks 63 are formed of a moulded refractory material. The process of manufacturing the arch segment wall modules 60 includes introducing a pliable or mouldable refractory material into a mould (not shown), which describes a plurality of block or brick cavities (not shown) and inserting the flexible spines 65 into the mould (not shown), such that they are embedded within the material in each brick cavity (not shown). Once the pliable or mouldable material has hardened or set, a moulded arch segment wall module 60 is removed from the mould (not shown). The keys 66 can then be inserted into the largest brick 63. In some examples, an insert (not shown) with an internal thread is inserted during the moulding process, or is subsequently forced into a blind hole drilled into the brick 63.

Each brick 63 is substantially rectangular with longitudinal and lateral sides 63b, 63c that converge from the outer side 63a of the brick 63 to an inner side 63d thereof. Convergence of the longitudinal sides 63b creates a taper in each brick 63 of the arch segment wall module 60, which provides a divergence in the longitudinal sides 63b between each consecutive brick 63. This divergence, together with the hinged connection provided by the flexible spine 65, enables the arch segment wall module 60 to be movable from a first, substantially flat configuration (shown in FIGS. 6 and 7) to a second, e.g. arched, configuration (shown in FIGS. 8 and 9). This is achieved by pivoting the bricks 63 relative to one another about the hinged connection provided by the flexible spine 65, until their longitudinal sides 63b abut one another.

Convergence of the lateral sides 63c creates a taper along the length of the arch segment wall modules 60. This taper enables a curved profile to be created about the periphery of the modular dome structure 5 as the arch segment wall modules 60 are brought into abutment with one another. In addition, the lateral sides 63c converge from the lowermost, mounting brick 63 to the uppermost brick 63, such that the length of each consecutive brick 63 along the arch segment wall modules 60 reduces. It will be appreciated by those skilled in the art that this will create a modular dome structure 5 having a substantially hemispheric profile, as illustrated more clearly in FIG. 5.

The base 7 includes a polygonal insulative block (not shown), an oven floor 71 and a registration plate 72 between the insulative block (not shown) and oven floor 71. The oven floor 71 includes a peripheral floor slab 71a, which sits atop a further, circular insulative block (not shown) that matches the inside of the modular dome structure 5. The peripheral floor slab 71a has a circular recess that receives four quarter-circular floor slabs 71b, 71b′ 71c. The oven floor 71 also includes a door slab 71d, which sits atop a correspondingly shaped insulative block (not shown) and abuts the peripheral floor slab 71a. One of the floor slabs 71c, shown in FIG. 11, includes an aperture A through its thickness. The other three floor slabs 71b, 71b′ include a pair of identical, quarter-circular floor slabs 71b and one quarter-circular floor slab 71b′ having a truncated part-circular side that coincides with a flat side of the door slab 71a.

The registration plate 72, shown more clearly in FIG. 12, has a substantially polygonal periphery, with eleven straight edges and a rounded front, with a peripheral wall 72a depending from its periphery. The registration plate 72 includes an aperture B through its thickness, a plurality of wall module registration slots 73, 74, 75, 76, 77 and a pair of hood registration slots 78a, 78b. The wall module registration slots 73, 74, 75, 76, 77 are inboard of the periphery of the registration plate 72. The aperture B is on the left side of the registration plate 72, in the orientation shown in FIG. 12. It will be appreciated by those skilled in the art that the configuration of the registration plate 72 will vary, depending on the size and/or configuration of the oven 1. For example, the number, position, size and configuration of the wall module registration slots 73, 74, 75, 76, 77 and hood registration slots 78a, 78b may vary.

The wall module registration slots 73, 74, 75, 76, 77 include a pair of spaced initiating slots 73, a series of five right-sided slots 74, a series of four left-sided slots 75, a right-side door slot 76 and a left-side door slot 77. The right-sided slots 74 are distributed about the periphery of the registration plate 72 on the right side of the initiation slot 73, while the left-sided slots 75 are distributed about the periphery on the left side of the initiation slot 73. The right-side door slot 76 is at the end of the series of right-sided slots 74 and the left-side door slot 77 is at the end of the series of left-sided slots 75.

Each initiating slot 73 includes a circular enlarged portion 73a and a necked portion 73b extending from the enlarged portion 73a toward the periphery of the registration plate 72. Each right-sided slot 74 includes a first enlarged portion 74a and a necked portion 74b extending from the enlarged portion 74a toward the initiating slot 73. Each right-handed slot 74 also includes a second enlarged portion 74c in an intermediate part of the necked portion 74b. Similarly, each left-sided slot 75 includes a first enlarged portion 75a, a necked portion 75b extending from the enlarged portion 75a toward the initiating slot 73 and a second enlarged portion 75c in an intermediate part of the necked portion 75b. The right-side door slot 76 includes an enlarged portion 76a and a necked portion 76b extending from the enlarged portion 76a toward the last right-sided slot 74 in the series. Similarly, the left-side door slot 77 includes an enlarged portion 77a and a necked portion 77b extending from the enlarged portion 77a toward the last left-sided slot 75 in the series.

The lid 8, shown more clearly in FIGS. 4 and 5, is circular in plan with a flat apex 80. The lid 8 includes a series of threaded holes 81, the uppermost brick 63 of each arch segment wall module 60 also includes a threaded hole 67 and the upper doorframe module 62 also includes a series of threaded holes 68. The threaded holes 81, 67, 68 may be provided by threaded inserts, embedded during the moulding process or forced into holes after the moulding process. In the assembled condition, shown more clearly in FIGS. 2 and 3, the holes 81 in the lid 8 are aligned with the holes in each arch segment wall module 60.

In order to assemble the oven 1, the head 66a of each key 66 of a first arch segment wall module 60 is inserted into the enlarged portion 73a of a respective one of the initiating slots 73. The first arch segment wall module 60 is then forced outwardly such that the neck 66b of each key 66 slides into the necked portion 73b of the initiating slot 73 and abuts the end of the initiating slot 73. Then, the head 66a of each key 66 of a second arch segment wall module 60 is inserted into one of the enlarged portions 74a, 74c of the right-sided slots 74 and the second arch segment wall module 60 is forced toward the first arch segment wall module 60 until their castellations 64 engage. Similarly, the head 66a of each key 66 of a third arch segment wall module 60 is inserted into one of the enlarged portions 75a, 75c of the right-sided slots 75 and the third arch segment wall module 60 is forced toward the first arch segment wall module 60 until their castellations 64 engage. It will be appreciated by those skilled in the art that the use of two keys 66 ensures both the location and orientation of each arch segment wall module 60.

As indicated by the numbers on the registration plate, three further arch segment wall modules 60 are mounted to the base 7 in a similar fashion, alternating between the right-sided slots 74 and left-sided slots 75 as indicated by the sequence numbers N on the registration plate 72. As indicated by sequence number 7, the floor insulation block (not shown), the peripheral floor slab 71a and quarter-circular floor slabs 71b, 71b′, 71c are then placed on the registration plate 72, with the apertures A, B aligned. The remaining arch segment wall modules 60 are then mounted to the base 7, as described above and as indicated by the sequence numbers N. However, this sequence is but one example. For example, the floor insulation block (not shown) and floor slabs 71a, 71b, 71b′, 71c may be placed on the registration plate 72 after the first arch segment wall module 60 and before the others.

After all of the arch segment wall modules 60 have been installed, the side doorframe modules 61 are installed on the base 7 by inserting the keys (not shown) into the door slots 76, 77 and forcing the side doorframe modules 61 toward the adjacent arch segment wall modules 60 until their castellations 61a, 64 engage. The door slab 71d is then placed on the registration plate 72 in front of the peripheral floor slab 71a, over sequence number 14. The upper doorframe module 62 is then placed onto the side doorframe modules 61 such that the castellation 62a register with the uppermost castellation 64 of the adjacent arch segment wall modules 60.

The lid 8 is mounted onto the upper, free ends of the arch segment wall modules 60 and the upper doorframe module 62. A series of plates or locking bands (not shown) are secured to each hole pair 81, 67 and 81, 68 to secure the lid 8 relative to the arch segment wall modules 60. The wall modules 6 are inboard of the periphery of the base 7, thereby creating a ledge. A fire resistant filler or mortar is then inserted between the blocks or the spaces described between adjacent bricks 63 and the wall modules 6 of the modular dome structure 5 is covered with an insulative material (not shown).

The hood 3, 103 is then placed over the so-covered modular dome structure 5, such that the lower edge of the hood 3, 103 rests on the ledge and the tabs 38, 138 are inserted into the hood registration slots 78a, 78b. The chimney 4 is then mounted to the hood 3, 103 and the oven 1 is ready for use.

It will be appreciated by those skilled in the art that several variations to the aforementioned embodiments are envisaged without departing from the scope of the invention. For example, the arch segment wall modules 60 may have more or less spines 65 and/or keys 66 and/or bricks 63. The bricks 63 need not be offset and/or hinged to one another. The modular dome structure 5 need not be substantially hemispherical. It may be pyramidal or any other polygonal shape or otherwise.

The registration plate 72 may be replaced with a base having some other form of registration feature(s) or keyways formed therein or may be omitted entirely. The registration feature(s) of the base may comprise a projection, ridge or key and/or the registration features of the wall modules 60 may comprise a recess, notch or keyway. Alternatively, the registration features of the wall modules 60 may comprise a projection, ridge or key and/or the registration feature(s) of the base may comprise a recess, notch or keyway. In such cases, the wall modules 60 may merely rest on the base or registration plate 72. Additionally or alternatively, the modular dome structure 5 may comprise a strap secured to and wrapped around at least some of the wall modules 60 and/or the base.

In some examples, the modular dome structure 5 is replaced with a unitary structure over which the hoods 3, 103 may be removably mounted. It will also be appreciated by those skilled in the art that any number of combinations of the aforementioned features and/or those shown in the appended drawings provide clear advantages over the prior art and are therefore within the scope of the invention described herein.

1. A modular dome structure comprising a plurality of wall modules abutting one another to form a wall of the dome and a base upon which the wall modules are mounted, wherein each wall module comprises a plurality of bricks formed at least in part of a refractory material which are hingedly interconnected together by a flexible spine that is at least partially embedded within the brick, each wall module being shaped so as to form an arch segment of the dome wall when facing surfaces of adjacent blocks of the wall module abut one another.

2. (canceled)

3. The modular dome structure of claim 1, wherein each wall module comprises a first, mounting end which is mounted to the base and a second end opposite the first end.

4. The modular dome structure of claim 3, wherein at least one of the blocks in each wall module tapers toward the inside of the dome such that the wall module forms an arch segment.

5. The modular dome structure of claim 3, wherein the flexible spine extends from the first end of the wall module to its second end.

6. The modular dome structure of claim 5, wherein each wall module comprises a first registration feature at its first end, in registration with a second registration feature of the base to locate the wall module on the base.

7. (canceled)

8. The modular dome structure of claim 3 comprising a lid mounted on the free end of each wall module.

9. The modular dome structure of claim 8, wherein the structure comprises a chimney or flue in fluid communication with a door opening the aperture for evacuating combustion gases.

10. The modular dome structure of claim 1, wherein the flexible member or spine comprises one or more wires, e.g. one or more twisted multifilament wires.

11. The modular dome structure of claim 1, wherein the blocks of adjacent wall modules describe an interlocking pattern.

12-17. (canceled)

18. The modular dome structure of claim 1 comprising:
a removeable hood mounted over the wall modules; and
a thermally insulative and/or fire-retardant material either comprised within the hood or between the inner wall of the dome and the hood.

19. (canceled)

20. The modular dome structure of claim 1 comprising a fire resistant filler in one or more spaces described between adjacent blocks.

21. The modular dome structure of claim 1, wherein the base comprises an aperture for receiving or communicating with a gas burner.

22. The modular dome structure of claim 1 comprising an insulating material in or beneath the base and/or surrounding the wall modules.

23. An oven comprising the modular dome structure of claim 1.

24-30. (canceled)

31. An arch segment comprising a plurality of bricks including a refractory material which are hingedly interconnected together by a flexible spine at least partially embedded within each brick, wherein the bricks are shaped such that the arch segment is movable from a first, substantially flat configuration to a second, arched configuration when facing surfaces of adjacent bricks abut one another.

32. The arch segment of claim 31, wherein at least one of the bricks tapers toward an intended inner side of the arch segment.

33. The arch segment of claim 31, wherein the flexible spine extends from a first, mounting end of the arch segment to a second, free end thereof.

34-35. (canceled)

36. The arch segment of claim 31, wherein the flexible spine comprises one or more wires.

37. The arch segment of claim 31, wherein at least one brick is offset relative to an adjacent brick such that the arch segment interlocks, in use, with another arch segment to provide an interlocking structure.

38-40. (canceled)

41. A modular dome structure comprising:
a plurality of wall modules abutting one another to form a wall of the dome;
a base upon which the wall modules are mounted;
a removeable hood mounted over the wall modules; and
a thermally insulative and/or fire-retardant material either comprised in the hood or between the inner wall of the dome and the hood;
wherein each wall module comprises a plurality of blocks hingedly interconnected together and shaped so as to form an arch segment of the dome wall when facing surfaces of adjacent blocks of the wall module abut one another.
